(19) United States
(12) Patent Application Publication
(10) Pub. No.: US 2006/0166853 A1
(43) Pub. Date: Jul. 27, 2006

(54) Detergent composition exhibiting enhanced stain removal

(75) Inventor: Luc Feyt, Mont Saint-Guibert (BE)

Correspondence Address: Armstrong Kratz Quintos Hanson & Brooks, 502 Washington Avenue, Suite 220, Towson, MD, 21204, US

(73) Assignee: N. V. Solutia Europe S.A., Bruxelles (BE)

(21) Appl. No.: 10/530,978

(22) PCT Filed: Oct. 8, 2003
(86) PCT No.: PCT/EP03/11248

§ 371 Date: Jul. 22, 2005

(30) Foreign Application Priority Data
Oct. 10, 2002 (EP) 02079500.1

(51) Int. Cl. C11D 1/66

(52) U.S. Cl. 510/470; 510/510

(57) ABSTRACT

Detergent compositions are disclosed exhibiting enhanced bleachable stain removal in the substantial absence of detergent oxygen bleaches. The compositions contain, in addition to conventional detergent matrix ingredients, a binary system consisting of a specific inulin derivative in combination with a specific phosphonate component.

This invention relates to detergent compositions capable of exhibiting enhanced, in particular bleachable, stain removal properties. The inventive compositions contain conventional detergent constituents, including surface-active agents, builders, conventional detergent additives and optional components, and, in addition, from 0.1% to 5% by weight of a fructan component, selected from the group of carboxyalkylinulin, having from 1 to 4 carbon atoms in the alkyl moiety, dicarboxyinulin having a degree of oxidation of from 10% to 100%, 6-carboxyinulin, and fructanpolycarboxylic acid and from 0.1% to 5% by weight of an phosphonate. The weight ratio of the fructan component to the phosphonate component is preferably in the range of from 8:1 to 1:3 and most preferably in the range of from 4:1 to 1:1. The claimed detergent compositions can yield, within, for example, the context of conventional detergent laundering application, remarkable bleachable stain and soil removal, in particular in the absence of detergent bleaching systems based on oxygen perbleach compounds.

The use of conventional detergent bleach systems, frequently perborates, optionally in combination with perbleach activators such as TAED, can be difficult, possibly impossible, in situations where such bleach systems can cause fiber damage, will lead to colour changes of the garments being laundered and/or will lead to deactivation of detergent additives such as enzymes. In addition, conventional bleach systems lack storage stability, in particular upon incorporation into other than non-dry-powder detergents, particularly liquid and pasty detergents.

The prior art concerning detergent compositions is diverse and the majority of the individual components of the inventive compositions herein are known and can possibly have been suggested in connection with detergent application. WO 99/64551 relates to method for the treatment of textiles which can, in particular, be suitable for the removal of contaminants of natural origin which contaminants are frequently present on raw cotton and wool materials. To that effect, the textiles are treated with a fructan polycarboxylic acid/salt component. The fructan polycarboxylic acids can be represented by inulins containing preferably from 0.2 to 2.0 carboxyl groups per monosaccharide unit. WO 91/17189 pertains to a method for the preparation of calcium complexing polycarboxy compounds based on polysaccharides. The starting material can be inulin and polycarboxyinulin containing from 1.5 to 2 carboxyl groups per fructose unit can be obtained in virtually quantitative yield. The polycarboxy compounds so produced are suitable phosphate builder replacements or can be used in combination with, for example, known detergent builders such as zeolite NaA.

A. C. Besemer and H. van Bekkum, Carbohydrates as Organic Raw Materials III, edited by van Bekkum et al., pages 274-294, describe possibilities of using dicarboxy-starch and dicarboxy-inulin in replacement of phosphate and polyacrylate detergent builders. The feasibility of large scale application of dicarboxy-polysaccharides in combination with zeolite is emphasized. D. L. Verraest, J. A. Peters and H. van Bekkum, Zuckerind. 120 (1995) No 9, pages 799-803, describe methods for the conversion of inulin and sucrose into polycarboxylates. It is mentioned that such carbohydrate based carboxylates, for example as dicarboxyinulin, have a wide range of potential applications such as sequestering agent for Ca/Mg in detergent formulations, as dispersing agent or as metal ion carrier.

It is a main object of this invention sto provide detergent compositions exhibiting superior bleachable stain and soil removal properties. It is another object of this invention to provide superiorly performing detergent compositions having an improved environmental profile. Yet another object of this invention concerns a provision of detergents, which in the substantial absence of conventional bleach system, are capable of delivering quasi-bleach performance in situations where conventional oxygen-bleach systems are counterproductive and or cannot be used because of fiber damage, color fading and/or deactivation of sensitive ingredients including perfumes and enzymes. A further object of this invention aims at providing effective bleaching activity in using detergent compositions which are substantially-free of conventional oxygen bleach systems, usually a perbleach e.g. a perborate optionally combined with an activator therefor e.g. TAED.

The above and other benefits can now be achieved with detergent compositions containing a selective mixture of a fructan component in combination with a polyphosphonate component.

The “percentage” or “%” indications hereinafter stand, unless defined differently for “percent by weight”. The terms “phosphonate” and “phosphonic acid” are used, throughout the description and the claims, interchangeably; these terms obviously relate to prevailing (composition; during application) pH conditions.

It has now been discovered that specific detergent compositions, capable of delivering unusually enhanced bleachable stain removal performance, can be formulated. In particular, the compositions herein, which are substanially free of oxygen bleaches, contain surface-active agents, builders, conventional additives and optional components in combination with

I: of from 0.1 to 5% by weight of a fructan component selected from the group of:

(a) carboxyalkylinulin wherein the alkyl moiety contains from 1 to 4 carbon atoms;

(b) dicarboxyinulin having a degree of oxidation of from 10% to 100%, expressed as a molar percentage of monosaccharide units converted into the corresponding dicarboxy analogues;

(d) fructan polycarboxylic acid, having a degree of oxidative substitution of from 0.2 to 2.0 and a degree of carboxyalkylation or carboxyacylation of from 0.2 to 3.0; and

II: of from 0.1% to 5% by weight of a phosphonate selected from the group of:
(i) (R₂)ₐ—N—(R₁—PO₃H₂)ₙ₋ₐ;
   wherein R₁ is an alkylene group having from 1 to 4 carbon atoms, R₂ is an alkylene group having from 1 to 8 carbon atoms, a is 0, or 2 and n is 1, 2 or 3;
(ii) phosphonobutane tricarboxylic acid;
(iii) an alkylene polyphosphonate wherein the alkylene chain contains from 2 to 6 carbon atoms and the component contains at least two phosphonate groups; and
(iv) an alkylene polyaminopolyphosphonate; and
(v) a mixture of such phosphonates.

Preferred fructan components can be represented by carboxymethylinulin having a degree of substitution (DS) in the range of from 1.5 to 2.8 and by dicarboxyinulin having a degree of oxidation (DO) in the range of from 20% to 90%.

The detergent compositions can be represented by all known physical forms of detergents inclusive of powders, tablets, liquids, gels and other convenient executions well known in the detergent domain.

The fructan component is present in a level of from 0.1 to 5%, preferably of from 0.1 to 2%, most preferably of from 0.15 to 1.5%. Fructans are oligo- and polysaccharides which have a majority of anhydrofructose units. The fructans can have a polydisperse chain length distibution and can be straight- or branched-chain. Preferably, the fructan contains mainly β-2,1 bonds, as in inulin. The fructans can be products obtained directly from a vegetable source or other sources and products in which the average chain length has been modified, increased or reduced, by fractionation, enzymatic synthesis or hydrolysis. The fructans have an average chain length (degree of polymerization, DP) of at least 3 to about 1000. Preferably, the average chain length is from 3 to 60, in particular of from 5 to 30 monosaccharide units. A preferred fructan is inulin (β-2,1-fructan) or a modified inulin.

Modified fructans, suitable for use in accordance with the inventive technology, can be represented by fructans with enzymatically increased chain length, fructan hydrolysis products having shortened chains and fractionated products having a modified chain length. Fractionation of fructans such as inulin can be achieved, for example, by means of known technics including low temperature crystallization (see WO 94/01849), column chromatography (see WO 94/12541), membrane filtration (see EP-A-0440074, EP-A-0627490) or selective precipitation with alcohol. Hydrolysis to yield shorter fructans can be carried out, for example, enzymatically (endo-insulase), chemically (water and acid) or by heterogeneous catalysis (acid column). Reduced, oxidized, hydroxyalkylated and/or cross-linked fructans can also represent suitable starting materials.

The fructan component suitable for use can be represented by four different classes of fructan derivatives as follows:
(a) a carboxyalkylinulin having from 1 to 4 carbon atoms in the alkyl chain. The preferred alkyl moiety has one or two carbon atoms in the alkyl moiety; most preferred is carboxymethylinulin;
(b) dicarboxyinulin having a degree of oxidation of from 10% to 100%, expressed as a molar percentage of monosaccharide units converted into the corresponding dicarboxy analoques;
(c) 6-carboxyinulin;
(d) fructan polycarboxylic acid, having a degree of oxidative substitution of from 0.2 to 2.0 and a degree of carboxyalkylation or carboxyacylation of from 0.2 to 3.0; and
(e) mixtures thereof.

As already mentioned, carboxymethyl- and carboxyethylinulins are preferred alkyl species. Carboxymethylinulin can be prepared by reaction of the fructan with chloroacetic acid as described in WO 95/15984. Carboxyethylinulin can be prepared in accordance with the method of WO 96/34017. The carboxyalkylinulins so prepared can have a degree of substitution (DS) of up to 3.0. The DS of such carboxyalkylinulins is generally within the range of from 0.2 to 3.0, preferably from 1 to 2.8. Preferred carboxyalkylinulins for use within the claimed technology have a DS in the range of from 1.5 to 2.8, most preferably from 1.8 to 2.5. Carboxyalkylinulins having a DS above 2.8 are less desirable.

Dicarboxyinulins can be obtained through oxidation of the inulin raw material. The anhydrofructose units are converted, with ring opening, into dicarboxy(hydroxyethoxy)ethyleneoxy units. The oxidation can proceed in one step with hypohalite, as described in WO 91/17189, or in two steps with periodate and chlorite, as described in WO 95/12619. Preferred degrees of oxidation (DO) are in the range of from 20 to 90%, the DO being the (molar) percentage of monosaccharide units converted into the corresponding dicarboxy analogues.

6-Carboxy inulin is a well known material. It can be obtained by oxidation in accordance with the method of WO 95/07303.

Fructan polycarboxylic acid can be prepared by successive oxidation and carboxyalkylation of the selected starting material. The material has a DO of from 0.2 to 2.0 and a degree of carboxy-alkyl/-acyl substitution of from 0.2 to 3, preferably from 0.5 to 2.5.

The phosphonate component is generally present in a level of from 0.1 to 5%, preferably from 0.1 to 2%; more preferably from 0.1 to 1% and most preferably from 0.2 to 0.8%.

Suitable phosphonates can be selected from the group consisting of aminopolyphosphonates (i), in particular amino(trismethylenephosphonate); phosphonobutane tricarboxylic acid (ii); alkylene polyphosphonate (iii), in particular hydroxyethane diphosphonate; alkylene polyamino polyphosphonate (iv), in particular ethylene diamino tetramethylenephosphonate, diethylene triamino pentamethylenephosphonate, dihexyleneethylene tetraamino hexamethylenephosphonate and bishexamethylene triamino pentamethylenephosphonate; and mixtures thereof.

The compositions herein can be present in embodied in conventional forms, well known in the detergent domain, inclusive of powders, tablets, liquids, gels and other convenient executions as can be desirable.

Detergent compositions according to the present invention can contain a matrix (combination) of known detergent ingredients used for their known functionality in art established levels. As a first ingredient, detergent surfactants, including, nonionic, anionic, cationic, zwitterionic or amphoteric surfactants, or mixtures of such surfactants, can be used. Typical detergent surfactant levels are in the range of from 5% to 70%, usually of from 8% to 40%. Anionic surfactants can be represented by anionic sulfonates and sulfates. Individual examples of such anionic surfactants are C₁₂₋₁₈ alkansulfonates, C₇₋₁₅ alkylbenzenesulfonates, olefinsulfonates, C₁₀₋₁₆ alkylsulfates, and anionic surfactants derived from C₁₂₋₁₈ fatty alcohols such as coconut-, lauryl-, myristyl-, cetyl- or stearylalcohol. Nonionic surfactants can be represented by the reaction products of aliphatic alcohols, acids, amides or alkyl phenols with alkylene oxides having from 2 to 6 carbon atoms in the alkyl chain. Suitable alkylene oxide species can be represented by ethylene oxides, propylene oxides and/or butylenes oxides.

The compositions herein can furthermore contain any one, or combinations of, detergent ingredients selected from builders, solvents, perfumes, optical brighteners, dispersing agents, pH adjusting agents, fiber softeners, suds regulants, dyes, dye transfer inhibitors, enzymes and redeposition agents and additional detergent components well known in the art. Any of such components is used for its known functionality in known levels. The choice of any such component will, of course, vary depending upon the physical state, pH and application properties of a given composition.

Detergent builders are typically used in levels ranging from 5% to 50%, in liquid compositions frequently from 5% to 30%. Examples of suitable builders include polyphosphates, such as tripolyphosphates, pyrophosphates and polymeric meta-phosphates, alkali metal silicates, carbonates, polycarboxylates, such as oxydisuccinates, copolymers of maleic acid with ethylene or vinyl methyl ether, nitrilotriacetic acid, fatty acids, such as lauric —stearic acids, and combinations of such builders. Another class of suitable detergent builders is represented by zeolites such as synthetic crystalline aluminosilicate ion exchange materials known under the designations Zeolite A, Zeolite B, Zeolite P, Zeolite X, Zeolite HS, Zeolite MAP and mixtures thereof.

Suitable enzymes for use herein can be proteases, amylases lipases, cellulases, esterases, possibly peroxidases and mixtures thereof. The enzymes are generally present in levels in the range from 0.05% to 4%.

Fiber (fabric) through-the-wash softeners can be represented by quaternary ammonium softeners, impalpable smectite clays and by mixtures thereof. Such softener materials are, in accordance with needs, typically used at levels in the range of from 0.5% to 10%. Suitable suds suppressors can be represented by salts of monocarboxylic fatty acids having preferably from 12 to 18 carbon atoms in the hydrocarbyl chain.

Low molecular weight primary or secondary alcohols such as methanol, ethanol, propanol and isopropanol, are suitable for use in connection with liquid compositions of this invention.

The claimed technology was found to be particularly beneficial in connection with liquid detergent compositions in the substantial absence of oxygen bleaches.

The following comparative examples illustrate the benefits attached to the inventive technology as compared to closely related art executions.

A bleach-free liquid laundry detergent premix was prepared having the following composition.

| Ingredients | Parts by Weight |
|---|---|
| C₁₄₋₁₅ Oxoalcohol-8 EO | 12 |
| Coconut fatty acid | 10 |
| Potassium hydroxide 47% | 9.5 |
| 1,2-Propane diol | 4 |
| Water | 36.5 |
| Trisodium citrate dihydrate | 2 |
| Linear C₁₁₋₁₃ alkylbenzene sulfonic acid | 15 |
| Triethanolamine | 8 |
| Ethanol | 3 |

A carboxymethylinulin or a phosphonate or a mixture of a carboxyinulin and a phosphonate were, as recited below, added to individual portions of the premix. The so prepared individual compositions were dissolved at a concentration of 10 g/l. Standardized stain swatches with respectively Tea (EMPA 167) and Wine (EMPA 114) stains were washed for 20 minutes at 40° C. in a Terg-o-Tometer with 1 liter of water (147 ppm Ca⁺⁺ and 17 ppm Mg⁺⁺).

The stain removal was determined by means of an optical measuring device of the Datacolor Elrepho 2000 type. The results are expressed as the percentage difference in the Z value of the stained swatches before and after washing, using the following formula:
% Stain removal=(Z₁−Z₀)×100/(100−Z₀)
wherein: Z₀=reading before washing
Z₁=reading after washing.

The testing results were as follows.

Stain Removal (%)

| Additive | % | Tea | Wine |
|---|---|---|---|
| No additive | — | 13.8 | 43.5 |
| DTPMP | 0.5 | 16 | 46 |
| HEDP | 0.5 | 19 | 45.8 |
| CMI | 2 | 13.8 | 45 |
| HEDP | 0.5 | | |
| CMI | 2 | {24.8 | 48.4 |
| HEDP | 0.5 | | |
| CMI | 4 | {27.7 | 50.2 |

DTPMP=diethylene triamino pentamethylenephosphonic acid;

HEDP=hydroxyethylene(1,1-diphosphonate);

CMI=carboxymethylinulin (DS 2.0).

The foregoing results show that the detergent use of combinations of phosphonate/carboxymethylinulin components significantly, and against expectations, improves the bleachable stain removal performance of bleach-free heavy duty liquid laundry compositions.

1. Detergent composition, capable of exhibiting enhanced bleachable stain removal in the substantial absence of oxygen bleaches, containing surface-active agents, builders, conventional additives and optional components, characterized in that the composition comprises
I: of from 0.1% to 5% by weight of a fructan component selected from the group of:
(a) carboxyalkylinulin, wherein the alkyl moiety contains from 1 to 4 carbon atoms;
(b) dicarboxyinulin having a degree of oxydation from 10% to 100%, expressed as a molar percentage of monosaccharide units converted into the corresponding analogues;
(c) 6-carboxyinulin; and
(d) fructan polycarboxylic acid, having a degree of oxidative substitution of from 0.2 to 2.0 and a degree of carboxyalkylation or carboxyacylation of from 0.2 to 3.0; and
II: of from 0.1% to 5% by weight of a phosphonate selected from the group of:
(i) (R₂)ₐ—N—(R₁—PO₃H₂)ₙ₋ₐ;
wherein R₁ is an alkylene group having from 1 to 4 carbon atoms, R₂ is an alkylene group having from 1 to 8 carbon atoms, a is 0, or 2 and n is 1, 2 or 3;
(ii) phosphonobutane tricarboxylic acid;
(iii) an alkylene polyphosphonate wherein the alkylene chain contains from 2 to 6 carbon atoms and the component contains at least two phosphonate groups;
(iv) an alkylene polyamino polyphosphonate; and
(v) a mixture of such phosphonates.

2. The composition in accordance with claim 1 wherein the weight ratio of components I to II is in the range of from 20:1 to 1:6, preferably of from 10:1 to 1:4; more preferably of from 8:1 to 1:1

3. The composition in accordance with claim 1 wherein the alkylene polyamino polyphosphonate is represented by the following formula: 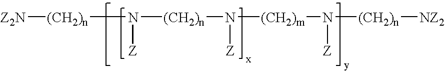
wherein
Z is —CHR¹PO₃R₂
R is H, CH₃, C₂H₅, or M;
M is a metal ion or ammonium;
R¹ is H, CH₃, or CH₂COOH;
n is 1-6, preferably 2-4;
m is 2-6, preferably 2-4;
x is 0-6, preferably 0-3;
y is 0-6, preferably 0-1.

4. The composition in accordance with claims 1 and 3 wherein the polyphosphonate is selected from the group of: ethylenediamino tetramethylenephosphonate; diethylene triamino pentamethylenephosphonate; dihexyleneethylene tetraamino hexamethylenephosphonate; bishexamethylene triaminopentamethylene phosphonate; phosphonobutane tricarboxylic acid; and amino(trismethylenephosphonic acid.

5. The composition in accordance with claim 1 wherein the fructan component is selected from carboxyalkylinulin having 1 or 2 carbon atoms in the alkyl moiety and having a degree of substitution of from 1.5 to 2.8 and dicarboxyinulin having a degree of oxidation (DO) of from 20% to 90%.

6. The composition in accordance with claims 1 and 5 wherein the fructan component is present in a level of from 0.1 to 2.0% by weight and the polyphosphonate is present in 0.1 to 2;0% by weight.
